(19) United States
(12) Patent Application Publication
(10) Pub. No.: US 2013/0290097 A1
(43) Pub. Date: Oct. 31, 2013

(54) AWARDING A GROUP- TARGETED PROMOTION

(71) Applicants: Filippo Balestrieri, Mountain View, CA (US); Zainab Jamal, Palo Alto, CA (US); Maria Teresa Gonzalez Diaz, Mountain View, CA (US)

(72) Inventors: Filippo Balestrieri, Mountain View, CA (US); Zainab Jamal, Palo Alto, CA (US); Maria Teresa Gonzalez Diaz, Mountain View, CA (US)

(21) Appl. No.: 13/458,266

(22) Filed: Apr. 27, 2012

(51) Int. Cl. G06Q 30/02

(52) U.S. Cl. 705/14.49

(57) ABSTRACT

Systems, methods, and computer-readable and executable instructions are provided for awarding a group-targeted promotion. Awarding a group-targeted promotion can include defining a first condition for a customer to join a list of promotion-eligible customers and defining a second condition for a number of groups of customers from the list to qualify for a group-targeted promotion. Awarding a group-targeted promotion can include awarding the group-targeted promotion to a group among the number of groups that complies with the second condition, wherein the method is performed by a computing device.

### BACKGROUND

A promotion can include an act to advertise a product, such as offering a special price to a customer and/or consumer for a product. Such an act can be conditional on a given response by the customer and/or consumer, for example, the purchase of the product within a given period of time. A promotion can be used to present information to customers and/or consumers, to increase demand for a product, and/or to differentiate a product. A promotion can include an internet advertisement, special events, endorsements, and newspaper advertisements, for example. A group-targeted promotion can include a promotion for a product and/or a service that may require a group of customers and/or consumers do something in order for each customer and/or consumer of the group to qualify for the promotion.

### BRIEF DESCRIPTION OF THE DRAWINGS

FIG. 1 is a flow chart illustrating an example of a method for awarding a group-targeted promotion according to the present disclosure.

FIG. 2 is a flow chart illustrating an example of a process for awarding a group-targeted promotion according to the present disclosure.

FIG. 3 is a block diagram illustrating a processor resource, a memory resource, and a computer-readable medium according to the present disclosure.

### DETAILED DESCRIPTION

Examples of the present disclosures can include methods, systems, and computer-readable and executable instructions and/or logic. An example method for awarding a group-targeted promotion can include defining a first condition for a customer to join a list of promotion-eligible customers and defining a second condition for a number of groups of customers from the list to qualify for a group-targeted promotion. An example method for awarding a group-targeted promotion can include awarding the group-targeted promotion to a group among the number of groups that complies with the second condition, wherein the method is performed by a computing device.

An example method for awarding a group-targeted promotion can include implementing a number of group-target promotions. Implementing a number of group-targeted promotions can include defining a number of second sets of conditions. Each of the number of second sets of conditions is associated with one group-targeted promotion and determines if the eligible customers/groups of customers from the list are entitled to an award of and/or receive benefits associated with that group-targeted promotion.

Promotions can be used by a company or a seller to market a product and can be used in a marketing campaign. Group-targeted promotions can include promotions that offer one or more benefits (e.g. a discount, free services, and gift cards) that are conditional on the actions of a group of customers. In other words, a group-targeted promotion may require numerous customers act to qualify for the promotion. Group-targeted promotions can include promotions that are activated when enough customers commit to buying one or more products or services, for example. However, the seller of the product may want to be able to design complex group-targeted promotions that require different set of actions by different categories of customers that may group together. And, not all interested customers may have the ability to find additional people to qualify for the group-targeted promotion.

By allowing a seller to set the first and second set of conditions, such as terms and conditions of a group-targeted promotion, the seller of the product may have a greater ability to more directly interact with specific segments of the seller's customer base. Interacting with the customers directly can improve the effectiveness of the marketing campaign involving the group-targeted promotion because the relationship between the incentive provisions of the sellers and the activities of the customers can be more transparent. Moreover, the seller may have the ability to harvest information about the characteristics of the seller's customer base and dynamically campaign using numerous group-targeted promotions to accomplish business needs as the needs arise over time.

In general, by providing a procedure to award a group-targeted promotion that utilizes consumers' social networks, a seller may have a greater opportunity to crowd-source some of the seller's marketing effort to the seller's customer base through a system of group-based incentives. The availability of social networks is growing and facilitates the effort of each consumer to look for other people that may be interested in sharing the benefits of a group-based promotion. A buyer interested in a group-targeted promotion can be induced to look in the buyer's own network for potential customers to form a group. However, by providing a process for interested consumers to group together without utilizing their individual social network (e.g., within a group-creation forum), interested customers may be able to engage in a group-targeted promotion even if the customer is unable to, does not know how to and/or does not want to exploit their own social network. Customers can earn a benefit from joining a group in a market-like fashion, depending on the contribution that the customer can bring to the group for the fulfillment of the second set of conditions.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit or digits correspond to the drawing figure number and the remaining digits identify an element or component in the drawing. Elements shown in the various figures herein can be added, exchanged, and/or eliminated so as to provide a number of additional examples of the present disclosure. As used herein, “a number of” an element and/or feature can refer to one or more of such elements and/or features. In addition, the proportion and the relative scale of the elements provided in the figures are intended to illustrate the examples of the present disclosure, and should not be taken in a limiting sense.

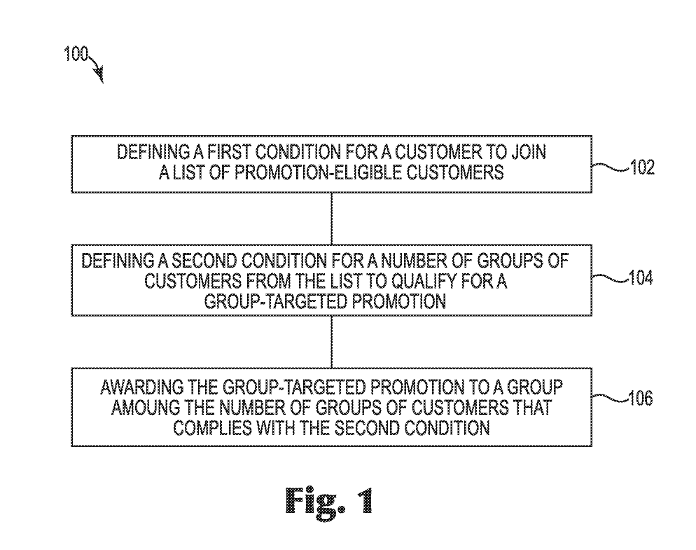

FIG. 1 is a flow chart illustrating an example of a method 100 for awarding a group-targeted promotion according to the present disclosure. The method 100 can be performed by a computing device. In some examples of the present disclosure, the method 100 can include implementing a number of group-targeted promotions.

At 102, a first condition can be defined for a customer to join a list of promotion-eligible customers. An eligible customer can include a customer and/or a group of customers, for example. A condition can include computer-executable instructions and/or logic that result in true or false outcomes. The first condition can include a rule and/or a set of rules, for example. A rule can be a condition with a set of actions to perform in response to returning true or false. A set of rules can include a collection of one or more rules, for example. A rule can have a conventional two-part form: an if-part defining a condition and a then-part defining a conclusion or action that is asserted if the condition is satisfied. Conditions can be simple or conditions can be complex conjunctions or disjunctions of multiple assertions.

A first condition can define a customer and/or a group of customers that can qualify for the list, and a customer and/or a group of customers that does not qualify, for instance. An example first condition, which can define a customer eligible to join the list, can, for example, include the following: if the customer is above the age of 18, add the customer to the list; if the customer is not above the age of 18, deny the customer from the list, where the customer is required to be above the age of 18 depending on law regarding the age of majority. The first condition can include, for instance, a requirement that a customer and/or group of customers apply to be added to the promotion list and/or provide an input indicating the customer and/or group of customers is interested in a group targeted-promotion associated with the promotion-eligible list.

The list of promotion-eligible customers can include a list of customers that comply with the first condition and are added to the list and/or a promotion list, for example. A customer can include, for example, a customer and/or a group of customers that is applying for a promotion list. For instance, a customer that complies with the first condition can be added to the list of promotion-eligible customers and can be eligible for the promotion. The promotion-eligible list can include a list associated with a number of group-targeted promotions, and, for example, a customer that complies with the first condition can be eligible for one or more of the number of group-targeted promotions. For instance, a customer that complies with the first condition can be eligible for all of the number of group-targeted promotions associated with the list.

For example, defining a first condition for a customer to join a list of promotion-eligible customers 102 can include a registration stage of method 100 for awarding a group-targeted promotion according to the present disclosure. The list of promotion-eligible customers, for example, can include a list associated with a number of group-targeted promotions running in parallel (e.g. a group-targeted promotion system). A registration stage, for instance, can define customers that are eligible for all the number of group-targeted promotions associated with the list and/or group-targeted promotion system. For instance, once a customer is eligible for the list, the customer can actively participate in the number of group-targeted promotions associated with the list and does not have to re-qualify for the list for each of the number of group-targeted promotions.

In some examples of the present disclosure, a first condition can be based on a first set of criteria received. For example, a first set of criteria can be input into a computing device and can be received from a seller of the group-targeted promotion and/or from a provider of the promotion-eligble list. A provider of the promotion-eligible list can include, for example, a group-targeted promotion forum provider, a creator of the promotion-eligible list, a web domain owner, a creator of a forum including a number of group-targeted promotions, among others.

The first set of criteria can include the requirements of a customer to qualify to join the list of promotion-eligible customers. Requirements of a customer to qualify can include definitions of individual customers qualified to join and/or groups of customers qualified to join. For example, requirements can include geographic location, age, gender, number of customers, date limitations for applying for the list, products previously bought, etc. The defined first condition based on the first set of criteria received from a seller and/or a provider of the promotion list, for instance, can determine a first number of groups of customers to qualify for the list of promotion-eligible customers and/or determine a number of customers eligible to join a promotion list.

At 104, a second condition can be defined for a number of groups of customers from the list to qualify for a group-targeted promotion. The second condition can include a rule or a number of rules, for instance. The second condition can include the duration of the promotion, whether the promotion is a closed promotion or open promotion, and/or additional (e.g., beyond the first condition) qualification requirements for a group to qualify for the award of the promotion, for example. The second condition can include rules about the assignment of benefits and/or rewards associated with the group-targeted promotion, and rules about how the benefits and/or rewards can be distributed across the customers that are members of the qualifying group of customers. A qualification requirement for a group to qualify for the promotion award can include a requirement that one or more actions (e.g., purchase a product and/or service) are executed by the members of the group, called critical acts. Different critical acts of a customer, for instance, can be associated with different qualifying groups.

For example, defining a second condition for a number of groups of customers from the list to qualify for a group-targeted promotions 104 can include a publication stage of method 100 for awarding a group-targeted promotion according to the present disclosure. The list of promotion-eligible customers, for example, can include a list associated with a number of group targeted promotions running in parallel (e.g. a group-targeted promotion system). A publication stage, for instance, can include a publication of the rules associated with one group-targeted promotion of the number of group-targeted promotions. For example, once a customer is eligible to join the list based on the first condition, the customer can actively participate in the number of group-targeted promotions associated with the list and can qualify for more than one of the number of group-targeted promotions based on the second conditions associated with each of the number of group-targeted promotions.

Qualifying for the group-targeted promotion can include determining that the group of customers qualifies for the benefit and/or benefits associated with the promotion. For example, qualifying for the group-targeted promotion can include a qualifying group of customers applying for the promotion and the seller of the promotion verifying the qualifying group of customers satisfies the second condition. A qualifying group of customers, for example, can apply for a group-targeted promotion and present evidence of the critical acts executed by the members of the qualify group of customers to comply with the second set of conditions associated with the group-targeted promotion. In some examples of the present disclosure, if the application from a qualifying group of customers is approved, the critical acts that were a part of the approved application cannot be used as a part of a different application to the same or any other ongoing group-targeted promotion.

A second condition, for example, can define a number of groups of customers from the list of promotion-eligible customers that can qualify (e.g., are eligible) for a group-targeted promotion and a number of groups of customers that do not qualify. The number of groups of customers can include a second number of customers among the first number of groups to qualify for the list of promotion-eligible customers, for example.

The second condition can be based on a second set of criteria defined and/or received from the seller of the promotion. For example, the second condition can include a requirement that a group of customers buy 100 computers within 90 days to qualify for the group-targeted promotion. As another example, the second condition can include a requirement that a group of customers buy 50 computers in North America, a 50 computers in Asia, and 100 extended warranties worldwide to qualify for the group-targeted promotion.

The method 100, in various examples of the present disclosure, can include two types of group-targeted promotions, a closed promotion and an open promotion. A closed promotion can include a number of customers and/or a number of groups of customers wherein the number of customers and/or groups of customers do not have access to a group-creation forum. In a closed promotion, for example, the number of customers/ groups of customers may not interact with one another in the method 100, for example.

For example, a closed group-targeted promotion can include a promotion wherein a first group of customers may not be able interact with a second group of customers, wherein the first group and the second group are among the number of groups of customers on the promotion-eligible list according to the first condition. The first group of customers, for instance, may have applied to the same group-targeted promotion as the second group of customers. A group of customers in a closed group-targeted promotion can be treated as a single entity, for instance.

A group of customers can include a single customer or a number of customers, for instance. A closed group-targeted promotion can allow a first customer to form a group with a number of customers that the first customer knows and/or the first customer locates independently of the promotion. For example, a first customer can locate a number of customers using a social network prior to requesting and/or applying to join the list of promotion-eligible customers. The customers can form groups prior to qualifying to join the list, and a group of customers may be required to comply with the first condition to be eligible to join the list.

In various examples of the present disclosure, the promotion can include an open promotion. An open promotion can include a promotion wherein the number of customers and/or number of groups of customers from the list can have access to a group-creation forum to form groups of customers to qualify for a group-targeted promotion and/or a number of group-targeted promotions. For example, an open group-targeted promotion can include a first customer and a second customer that comply with the first condition forming a group of customers. A group of customers, for instance, can be formed with or without input from the seller of the group-targeted promotion. For example, customers from the list can be grouped into a group of customers based on customer action (e.g., form a group including a first customer and a second customer in the group-creation forum). The group can be formed prior to or after joining the list of promotion-eligible customers.

A group-creation forum can include a market wherein the number of customers and/or number of groups of customers can interact by competing for new members (e.g., new customers and/or second customers) to join the number of groups to qualify for the benefits of a group-targeted promotion, for example. For instance, a first customer and a second customer can enter into a group-creation forum. The first customer can indicate an interest in a group-targeted promotion, form a qualifying group with a second customer, and the second customer can qualify for the group-targeted promotion.

In an open group-targeted promotion, for example, a first customer can include a demand customer (e.g., a first customer/group of customers that has a demand/need for a second customer to form a qualifying group for a group-targeted promotion). A second customer can include a supply customer (e.g. a second customer and/or group of customers with no affiliation to the first customer and with an interest in joining the first customer and/or an existing group of customers). The determination of the first customer being a demand customer and the second customer being a supply customer can include, for example, a decision by the demand customer and/or supply customer, and an assignment by the seller of the group-targeted promotion.

For instance, a demand customer can use the group-creation forum to search for new members to form a qualifying group (e.g., to add to the demand customer's group). The demand customer can search for customers that intend to execute acts (e.g., critical acts) that the demand customer needs to comply with the second condition associated with the group-targeted promotion. For example, the critical act that the supply customer intends to execute can include acts that the demand customer may need to qualify for the group-targeted promotion award. A demand customer, for instance, may determine and/or control how the benefits of an awarded group-targeted promotion are distributed between the customers of the qualifying group of customers through distribution award rules. The distribution award rules, for example, can be included in a bid by the first customer for the second customer.

A supply customer, for example, can include a customer that intends to execute an act (e.g., purchase a computer). The supply customer can utilize the group-creation forum to join a group of customers. For example, the supply customer can make it possible for a group of customers to qualify for the award of a group-targeted promotion according to the distribution award rules established by the demand customers (e.g., first customers).

The group of customers can include a group that complies with the second condition and/or a qualifying group, for example. Qualifying for a group-targeted promotion can include a group of customers applying for the promotion and the seller verifying the group of customers complies with the second condition, for example.

In some examples of the present disclosure, a group of customers can be formed by searching the promotion-eligible list for a second customer that can form a group of customers with a first customer to qualify for the group-targeted promotion. For example, in response to finding a first customer (e.g., demand customer) and a second customer (e.g., supply customer) in the group-creation forum that can form a qualifying group of customers, the first customer and the second customer can be automatically formed into a group of customers. The second customer, for instance, can indicate an act executed (e.g., critical act) and an interest in forming a group. The first customer can include a customer with a need for the act executed by the second customer to qualify for a group-targeted promotion, for example.

In some examples of the present disclosure, searching the list can include searching for a group of customers that can form a group with a customer in the group-creation forum to qualify for the group-targeted promotion. For example, the group of customers can include a group with a need for an executed act to qualify for a group-targeted promotion. The customer, for example, can include a customer that has executed the act needed by the group of customers.

The method 100, in various examples of the present disclosure, can include auctioning a customer from the list to a group of customers from the list to form a qualifying group of customers with the group of customers to qualify for the group-targeted promotion. In some examples, the method 100 can include auctioning a group of customers from the list to a customer from the list to form a qualifying group of customers with the customer to qualify for the group-targeted promotion.

For example, if an auction includes a number of groups of customers (e.g., first customers and demand customers) that are searching for additional new members of customers (e.g., second customers, a number of second customers, and supply customers) to join a group than are available, the number of groups of customers can competitively bid by offering parts of the group-targeted promotion and/or benefits associated with the award of the group-targeted promotion to the new members. If an auction, for example, includes new members of customers (e.g., second customers and supply customers) that are more numerous then the number of groups of customers (e.g., first customers and demand customers) that are searching for new members, the new members of customers can competitively bid by offering to associate with a group of customers among the number of groups (e.g., the new members offer critical acts executed and/or intended to execute to the group) in exchange of some benefits associated with the award of the group-targeted promotion. Thereby, depending on the competition in the auction, one of the two sides of the auction can take advantage of the market to gain extra benefits associated with the group-targeted promotion.

In various examples of the present disclosure, a method 100 can include a number of group-targeted promotions. In a method 100, involving a number of promotions, an open promotion can allow a number of groups of customers (e.g., first customers and demand customers) that may be participating and/or interested in one or more of the number of group-targeted promotions to compete for the same second customers (e.g., a supply customer and a supply group of customers) to qualify for numerous group-targeted promotions. And, in a method 100, involving a number of group-targeted promotions, an open promotion can allow individual customers (e.g., second customers) to consider joining a number of groups of customers (e.g., first customers) that may be participating and/or interested in one or more of the number of group-targeted promotions. For example, a group-creation forum with a number of group-targeted promotions can include interactions between a number of customers participating in one, many, and/or all of the multiple group-targeted promotions.

At 106, the group-targeted promotion can be awarded to a group of customers among the number of groups of customers that complies with the second condition. Awarding a group-targeted promotion can include distributing the promotion to a qualifying group of customers. For example, the group-targeted promotion can be awarded in response to a group of customers applying for the promotion and the seller of the promotion verifying that the group of customers complies with the second condition. Complying with the second condition can include a group of customers that satisfies the criteria the second condition is based upon, for example.

In various examples of the present disclosure, the method 100 can include collecting applications for the group-targeted promotion from the number of groups from the list. For instance, the number of groups from the list can include a number of applying groups of customers. The number of applying groups of customers, for example, can include a qualifying group of customers and a qualifying group of customers formed in a group-creation forum. An applying group of customers can send an application for the group-targeted promotion and, in response to receiving the application, the method 100 can include verifying that the applying group of customers complies with the second condition. If the applying group complies with the second condition, the group-targeted promotion can be awarded to the applying group, for example.

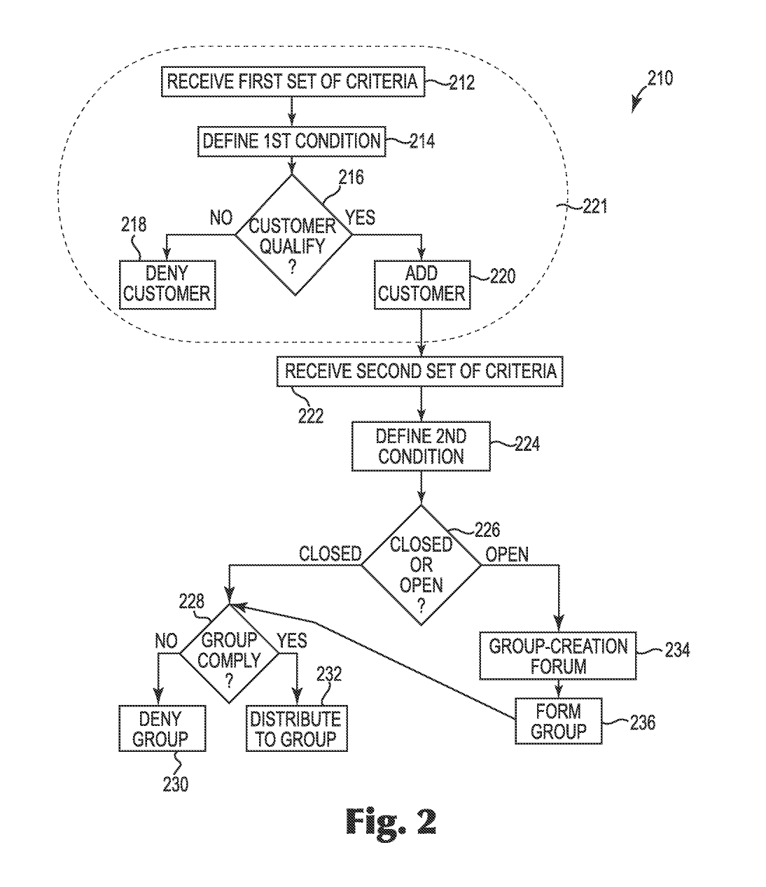

FIG. 2 is a flow chart illustrating an example of a process 210 for awarding a group-targeted promotion according to the present disclosure.

At 212, a first set of criteria can be received. For example, a seller of the one or more group-targeted promotions and/or provider of the group-targeted promotion system can input a first set of criteria. A first set of criteria can include a single criterion or a number of criteria for a group of customers to qualify for the list. At 214, a first condition can be defined based upon the first set of criteria received. The first condition can be used to determine a first number of customers that may be eligible to join a promotion-eligible list. A promotion-eligible list, for example, can include a number of group-targeted promotions.

At 216, a determination can be made as to whether a customer can join (e.g., qualifies) for a list of promotion-eligible customers based on the first condition. A customer can include a single customer, a number of customers, and/or a group of customers, for example. The first condition, in some examples of the present disclosure, can be based on criterion requiring identification of the number of customers in each of the first number of groups to qualify for the list. The determination of whether a group of customers qualifies for the promotion-eligible list can be made in response to a customer and/or a group of customers applying to join the list of promotion-eligible customers. Applying to join the list can include requesting to join the list, for example.

Based on the defined first condition, at 218, a customer can be denied from the promotion-eligible list in response to the customer not qualifying for the list. A customer and/or group of customers, for example, may not qualify for the list if the customer and/or group of customers does not comply with the first condition. A customer and/or group of customers may not comply with the first condition if the customer and/or group does not satisfy the first set of criteria received from a seller and/or a provider the group-targeted promotion system, for instance. For example, a first condition can include a fee and/or entrance fee that must be paid by a customer and/or group of customers to qualify for the list.

Based on the defined first condition, at 220, a customer can be added to the list in response to determining the customer qualifies for the list. The list can include a first number of groups of customers and/or a first number of customers that qualify for the list of promotion-eligible customers, for example.

For example, the steps for customers qualifying/ joining the list of promotion-eligible customers (e.g., 212-220) can include a registration stage 221 of the process 210 for awarding a group-targeted promotion according to the present disclosure. The list of promotion-eligible customers, for example, can be eligible for a number of group targeted promotions running in parallel (e.g. a group-targeted promotion system). A registration stage, for instance, can define customers that are eligible for all the number of group-targeted promotions associated with the list and/or group-targeted promotion system. For instance, once a customer is eligible for the list based on the first condition, the customer can actively participate in the number of group-targeted promotions associated with the list and does not have to re-qualify for the list for each of the number of group-targeted promotions.

At 222, a second set of criteria can be received. The second set of criteria can be received from the seller of the group-targeted promotion, for example. The second set of criteria can include the description of the terms and conditions of a specific group-targeted promotion, qualification requirements for a number of groups of customers to qualify for an award of a group-targeted promotion (e.g., for the award of a specific group-targeted promotions), and/or can include requirements for a second number of groups of customers among the first number of groups of customers to qualify for an award of a group-targeted promotion, for example. The number of groups of customers can include a number of groups of customers among the number of customers to qualify for the list.

At 224, a second condition can be defined based upon the second set of criteria received. A second condition can include a rule and/or a number of rules for a second number of groups of customers among the first number of groups to qualifying for a group-targeted promotion. For example, a second condition can be used to determine a second number of groups of customers among the first number of groups of customers and/or a number of groups of customers to qualify for an award of a group-targeted promotion. A second condition, for example, can include a rule and/or a number of rules for the distribution of the rewards and/or benefits associated with the group-targeted promotions among the members of a qualifying group. For example, the second condition can include instructions to identify a number of customers in a qualifying group for the qualifying group of customers to comply with the second condition.

The second condition, in some examples of the present disclosure, can be based on criterion requiring identification of the number of customers in a qualifying group of customers for the groups to qualify for the group-targeted promotion. For example, a second condition may be based on a criterion that a qualifying group of customers include representatives of different age intervals (e.g., one customer between the age of 18-25, one customer between the age of 25-32, one customer 32 and older). As another example, a second condition can require that the group of customers have a threshold number of customers (e.g., ten, fifty, and one hundred). The second condition, for instance, may require that each member of a qualifying group of customers perform a critical act.

At 226, a determination can be made as to whether the group-targeted promotion is an open promotion or a closed promotion. A closed promotion can include a promotion wherein the group of customers (e.g. the number of groups of customers on the promotion-eligible list) may not have access to a group-creation forum and/or may not be able interact with one another. An open promotion can include a promotion that allows customers and/or groups of customers on the promotion-eligible list to form a qualifying group of customers through a group-creation forum of supply customers and/or supply groups of customers and demand customers and/or demand groups of customers to qualify for the promotion, for example. For instance, a seller of the group-targeted promotion can indicate if the promotion is open or closed. The indication can be included in the second condition, the second set of criteria, and/or a separate input by the seller, for example.

In response to determining the group-targeted promotion is a closed promotion, at 228, a determination can be made as to whether a qualifying group of customers complies with the second condition. The qualifying group of customers can be from the second number of groups of customers, for example. Complying with the second condition can include satisfying the second set of criteria received from the seller of the group-targeted promotion. In response to a qualifying group of customers not complying with the second condition, at 230, the qualifying group can be denied the award of the group-targeted promotion. Denying the award can include sending a message to the qualifying group of customers that the group is denied the group-targeted promotion and/or indicating the reasons for not being awarded the group-targeted promotion (e.g., identify missing critical acts), among others.

At 232, in response to determining a qualifying group of customers complies with the second condition, an award of the group-targeted promotion can be distributed to the qualifying group. Determining that a qualifying group qualifies for an award of a group-targeted promotion can include verifying that the required critical acts (e.g., acts described in the second condition and second set of conditions) were executed by one or more members of the qualifying group of customers. Distributing the group-targeted promotion can include awarding the promotion to the qualifying group, for example.

In various examples of the present disclosure, the process 210 for awarding a group-targeted can include collecting applications to the group-targeted promotion from the second number of groups of customers and/or from a number of applying groups of customers. A number of applying groups of customers, for example, can include a qualifying group of customers formed in a group-creation forum. For instance, an application to the group-targeted promotion can be received from an applying group of customers. Determining if an applying group of customers complies with the second condition can include and/or be made in response to receiving an application for the group-targeted promotion from the applying group of customers and verifying that the applying group of customers complies with the second condition. An application for the group-targeted promotion can include a request for distribution, request for an award of the group-targeted promotion, and/or applying for the award of the group-targeted promotion, for example.

If it is determined that the group-targeted promotion is an open promotion, at 234, a customer on the promotion-eligible list can have access to a group-creation forum. Determining the group-targeted promotion is an open promotion can be based on an indication from a seller of the group-targeted promotion, for example. A group-creation forum can be used to form qualifying groups of customers and for awarding a group-targeted promotion, for instance.

In various examples of the present disclosure, the process 210 can include determining whether a customer (e.g., first customer and group of customers) that has joined the promotion-eligible list has a need for a second customer (e.g., additional members) in an open promotion. For instance, a group of customers that joins the promotion-eligible list may, based on the second condition, have a need for an additional member and/or members to join the group to qualify for the group-targeted promotion. The additional member and/or members may have executed or intend to execute critical acts associated with the group-targeted promotion.

In response to determining a customer (e.g., first customer) has a need for a second customer, a first input from a first customer can be matched to a second input from a second customer. Matching can include comparing the first input to the second input and/or searching the list of promotion-eligible customers for a second input that matches the first input, for example. A first input can include group-targeted promotions a first customer is interested in receiving and/or critical acts performed by a second customer that the first customer may be interested in, for example. A second input can include critical acts that a second customer executed and/or is intending to execute and group-targeted promotions a second customer may be interested in receiving a share of the award, for example. In such an example, the first customer may be a demand customer and the second customer may be a supply customer, and forming a group of customers with the first customer and the second customer can occur in a group-creation forum.

For example, a first customer (e.g., a demand customer) that has a need for second customers to qualify for a group-targeted promotion can be matched to a second customer (e.g., a supply customer) that has executed the critical acts necessary for the group to qualify for the award and is interested in receiving a share of the group-targeted promotion award. The need can be determined, for example, based on an input (e.g., first input) from the first customer indicating a need for a second customer and/or in response to the first customer being denied the group-targeted promotion for failing to comply with the second condition, among others. The demand customer and supply customer can be matched by the seller based on inputs of the demand customer and supply customer, and can be matched independently of the seller in an auction, for example.

A group-creation forum can include, for example, groups of customers searching (e.g., looking) for a second customer (e.g., demand customers) and second customers/individual customers searching (e.g., looking) for a group of customers (e.g., supply customers) to join. The demand customer (e.g., the first customer) and the supply customer (e.g., the second customer) may be matched if they share a common interest. The common interest, for example, can include an interest in the same group-targeted promotion and/or a common critical act performed and/or needed. A first input and a second input can include a group-targeted promotion that the customer is searching for and/or a promotion the customer has to offer, for example.

In various examples of the present disclosure, the group-creation forum can include an automatic matching system (e.g., automatic matching market). An automatic matching system can include automatically forming a qualifying group with the first customer and the second customer, in response to the first input and the second input matching. For example, a seller of the group-targeted promotion can indicate that the open promotion can include an automatic matching system to automatically form a group of customers based on matching inputs of a demand customer (e.g., a group of customers that may not qualify for the group-targeted promotion) and a supply customer (e.g., an individual that is interested in the group-targeted promotion). The indication by the seller, for example, can be included in the second set of criteria, the second condition, and/or a separate input.

In some examples of the present disclosure, the seller of the group-targeted promotion can establish (e.g., pre-establish) the share of the group-targeted promotion award that is assigned to each one of the members of the qualifying group of customers prior to awarding the group-targeted promotion to the qualifying group of customers (e.g., within the second set of criteria, the second condition, and a separate input).

In some examples of the present disclosure, a first input can match a number of second inputs from a number of second customers. For instance, the first customer can automatically be matched to a second customer among the number of second customers. The match, for example, can be made by a seller of the group-targeted promotion, a provider of the promotion-eligible list (e.g., the group-targeted promotion system), and/or can be made randomly.

In various examples of the present disclosure, the group-creation forum can include an auction based market (e.g., auction system). For example, a seller of the group-targeted promotion can indicate that the open promotion can include an auction based market to match supply customers to demand customers. The indication by the seller, for example, can be included in the second set of criteria, the second condition, and/or a separate input. In an auction based market, a sublist can be created of all second inputs that match the first input. For example, all second inputs can include a sub-number of customers from the list that have an input that matches the first input from the first customer and/or a number of first customers.

In various examples of the present disclosure, the sublist can include a sub-number of groups from the list of customers, wherein the sub-number of groups have an input matching the first input from the first customer. The first customer can include a first customer or a first group of customers. The sub-number of groups from the list can include a number of groups that may require an additional customer to qualify for a group-targeted promotion, for example.

In an auction based market, for instance, a set of first inputs can be distinguished from a set of second inputs. The set of first inputs can be associated to a first customer (e.g., demand customer) and the set of second inputs can be associated to a second customer (e.g., supply customer). The set of first inputs provided by a first customer can include a list of critical acts executed and/or offered by a second customer that would qualify the second customer to be added to a group of customers (e.g., a group including the first customer). The set of second inputs provided by a second customer can include critical acts executed and/or offered to be executed by the second customer that is interested in joining a group for a group-targeted promotion and/or a number of group-targeted promotions.

An auction based market can include, for example, a forum and/or platform that can be provided to the first customer to bid to the sublist of a sub-number of customers or the sublist of the sub-number of groups to form a qualifying group of customers. In some examples of the present disclosure, the auction forum and/or platform can be provided to the first customer to bid on critical acts executed and/or offered to be executed by the second customer and/or a number of second customers by offering shares of a group-targeted promotion to the second customer and/or number of second customers.

In some examples of the present disclosure, the auction forum and/or platform can be provided to the second customer to bid on the first customer and/or a number of first customers by offering to form a group with the first customer in exchange for a share of the group-targeted promotion award. The bid, for example, can be for a share of the promotion award conditional on the qualifying group of customers (e.g., group of customers including the first customer and the second customers formed in the group-creation forum) qualifying for the group-targeted promotion award. The outcome of the auction can include a match between the first customer that has won the auction and the second customer associated with the object (e.g., executed act, critical act, and group membership) auctioned.

In response to an auction and/or automatic matching, a group can be formed with the first customer and a second customer, at 236. For example, a formed group of customers can include a second customer that accepts an offer from a first customer in the auction to form a qualifying group of customers and/or a first customer that accepts an offer from a second customer to form a qualifying group of customers. In an automatic matching system, the qualifying group of customers can automatically be formed based on a match between a first input and a second input. Automatic matching, for example, can be operated by the seller of the group-targeted promotion based on the interest in a group-targeted promotion.

In various examples of the present disclosure, a group-targeted promotion system and/or promotion forum can host a number of group-targeted promotions running in parallel and a second customer may be interested in one or more of the number of group-targeted promotions. For example, the second customer can be matched to one or more of a first customer for one or more group-targeted promotions within the system at the same time.

In some examples of the present disclosure, if no match between a first input from a first customer and a second input from a second customer is found, an indication of the inability to find a match can be sent to the first customer and/or the second customer. An inability to find a match can include a failure to find a second customer with a second input matching the first input, for example.

At 228, a determination can be made as to whether the group of customers formed in the group-creation forum (e.g., qualifying group of customers) complies with the second condition. A determination can include verifying the qualifying group of customers complies with the second condition, for example.

In some examples of the present disclosure, the process 210 can include collecting applications for the group-targeted promotion from a number of applying groups of customers, wherein the number of applying groups of customers includes the qualifying group of customers formed in the group-creation forum. For example, the determination as to whether the qualifying group of customers complies with the second condition can be made in response to receiving an application to the group-targeted promotion from the qualifying group of customers.

In response to determining the qualifying group of customers formed in the group-creation forum complies with the second condition, at 232, an award of the group-targeted promotion can be distributed to the qualifying group. The distribution of an award can be across the members of the qualifying group of customers that satisfy the conditions emerged during the matching process in the group-creation forum (e.g., distribution award rules). In an example of the present disclosure, in an open promotion with auction based matching, the benefits and/or reward shares assigned to each customer in a qualifying group of customers can be determined by the winning bid in the auction.

At 230, in response to determining the group of customers formed in the group-creation forum (e.g., qualifying group of customers and applying group of customers) does not comply with the second condition, the group can be denied the group-targeted promotion.

In various examples, in an open promotion, a group of customers and/or a customer may not participate in the group-creation forum. For example, a group of customers and/or a customer may not have a need for a second customer, and may apply for a group-targeted promotion without participating in the group-creation forum. For instance, in response to determining a customer does not need a second customer, a determination can be made as to whether the customer complies with the second condition (e.g., 228). Determining a customer (e.g., first customer) does not need a second customer can include an input from the customer indicating the customer does not need a second customer, the customer applying (e.g., an application) for the award of the group-targeted promotion, and/or an indication from the seller of the group-targeted promotion, for example.

In some examples of the present disclosure, denying a qualifying group and/or applying group of customers a group-targeted promotion can include indicating the reasons the group may not comply with the second condition. The reasons can be provided in a message to the qualifying and/or applying group, for example. In some examples of the present disclosure, the denied qualifying group and/or applying group of customers for an open group-targeted promotion can provide a first input. The first input can include the group-targeted promotion the qualifying group and/or applying group is interested in receiving and/or interested in offering. For example, if a group was denied an open group-targeted promotion for ten percent off five computers because the group has not satisfied the second condition, the group can provide a first input to find a second customer that would assist the group in complying with the second condition.

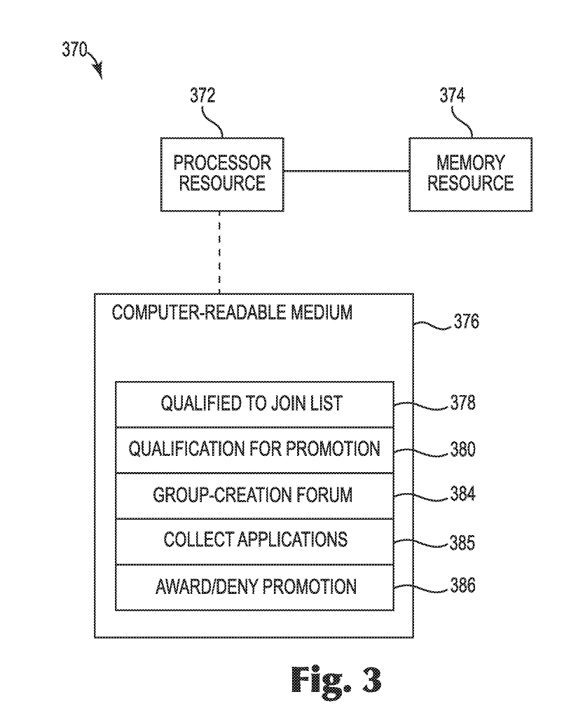

FIG. 3 is a block diagram 370 illustrating a processor resource 372, a memory resource 374, and a computer-readable medium 376 according to the present disclosure. The computer-readable medium (CRM) 376 (e.g., a tangible, non-transitory medium) and/or the memory resource 374 can store a set of instructions executable by the processor resource to determine a number of customers qualified 378 to join a promotion-eligible list based on a first condition, and determine qualification requirements 380 for a group-targeted promotion based on a second condition. The determination of a number of customers qualified to join the promotion-eligible list can be in response to the number of customers applying for the promotion-eligible list, for example.

The instructions can be executed to collect applications 385 for the group-targeted promotion from a number of applying groups of customers, wherein the number of applying groups of customers includes a qualifying group of customers formed in a group-creation forum. In various examples of the present disclosure, the instructions can be executed to form a qualifying group of customers including a first customer and a second customer in a group-creation forum 384. For example, a qualifying group of customers can be formed based on comparing a first input from a first customer from the list to a second input from a second customer from the list and form a qualifying group of customers in response to the first input and the second input matching. The qualifying group of customers can be automatically formed, for example, in response to the first input from the first customer matching the second input from the second customer.

The instructions can be executed to award the group-targeted promotion 386 to the qualifying group of customers in response to verifying the qualifying group of customers complies with the second condition, and deny the group-targeted promotion to an applying group of customers from the number of applying groups of customers in response to not verifying the applying group of customers complies with the second condition. Not verifying can include the applying group of customers not satisfying the requirements associated with the second condition, for example.

The instructions can be executed, in various examples of the present disclosure, to notify a first customer of an inability to match a first input to a second input, in response to not identifying a second input that matches a first input. Notifying the first customer can include sending a message to the first customer that a matching second input could not be found and/or located, and indicating the critical acts that could found and/or located, among others.

In some examples of the present disclosure, the instructions can be executed to create a sublist of a sub-number of customers from the list of promotion-eligible customers and provide a forum for a first customer to auction to the sublist of customers to form a qualifying group with the first customer. The sub-number of customers can include a number of customers with an input matching the first input from the first customer. The first customer can comprise a single customer and/or a group of customers, for example.

In some examples of the present disclosure, the instructions can be executed to create a sublist of a sub-number of groups of customers from the list of promotion-eligible customers and provide a forum for a first customer to auction to the sublist of the groups of customers to form a qualifying group with the first customer. The sub-number of groups of customers can include a number of groups with an input matching the first input from the first customer.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A computer-implemented method for awarding a group-targeted promotion comprising:
defining a first condition for a customer to join a list of promotion-eligible customers;
defining a second condition for a number of groups of customers from the list to qualify for a group-targeted promotion; and
awarding the group-targeted promotion to a group among the number of groups that complies with the second condition;
wherein the method is performed by a computing device.

2. The method of claim 1, wherein the method further includes collecting applications for the group-targeted promotion from the number of groups from the list.

3. The method of claim 1, wherein a first condition includes a rule for groups of customers to join the list.

4. The method of claim 1, wherein the first condition includes a rule based on a first set of criteria for the customer to join the list

5. The method of claim 1, wherein the second condition includes a rule based on a second set of criteria for the number of groups of customers from the list to qualify for the group-targeted promotion.

6. The method of claim 1, wherein the method further includes grouping customers from the list into the group based on customer action.

7. The method of claim 1, wherein the method further includes searching the list for a second customer that can form the group with a first customer from the list to qualify for the group-targeted promotion.

8. The method of claim 7, wherein the second customer executes an act and indicates an interest in forming the group, and wherein the first customer has a need for the executed act to qualify for the group-targeted promotion

9. The method of claim 1, wherein the method further includes searching the list for a group of customers that can form the group with a first customer from the list to qualify for the group-targeted promotion.

10. The method of claim 9, wherein the group of customers has a need for an executed act to qualify for the group-targeted promotion, and wherein the first customer has executed the act.

11. The method of claim 1, wherein the method further includes auctioning a customer from the list to a group of customers from the list to form a qualifying group of customers with the group of customers to qualify for the group-targeted promotion.

12. The method of claim 1, wherein the method further includes auctioning a group of customers from the list to a customer from the list to form a qualifying group with the customer to qualify for the group-targeted promotion.

13. A non-transitory computer-readable medium storing a set of instructions for awarding a group-targeted promotion executable by the computer to cause the computer to:
define a first condition based on a first set of criteria received from a seller for a first number of groups of customers to join a list of promotion-eligible customers;
define a second condition based on a second set of criteria received from the seller for a second number of groups of customers among the first number of groups to qualify for an award of a group-targeted promotion;
collect applications to the group-targeted promotion from the second number of groups of customers;
determine a qualifying group of customers from the second number of groups that complies with the second condition; and
distribute an award of the group-targeted promotion to the qualifying group of customers.

14. The non-transitory computer-readable medium of claim 13, wherein the instructions are executable to receive an application to the group-targeted promotion from an applying group of customers.

15. The non-transitory computer-readable medium of claim 13, wherein the instructions are executable to verify that an applying group of customers complies with the second condition in response to receiving an application to the group-targeted promotion from the applying group of customers.

16. A system for awarding a group-target promotion comprising:
a processor resource; and
a memory resource coupled to the processor resource and configured to direct the processor resource to:
determine a number of customers qualified to join a promotion-eligible list based on a first condition;
determine qualification requirements for a group-targeted promotion based on a second condition;
collect applications for the group-targeted promotion from a number of applying groups of customers, wherein the number of applying groups of customers includes a qualifying group of customers formed in a group-creation forum;
award the group-targeted promotion to the qualifying group of customers in response to verifying the qualifying group of customers complies with the second condition; and
deny the group-targeted promotion to an applying group of customers from the number of applying groups of customers in response to not verifying the applying group of customers complies with the second condition.

17. The system of claim 16, wherein the memory resources are further configured to direct the processor resources to match a first customer from the list to a second customer by automatically forming the qualifying group of customers with the first customer and second customer, in response to a first input from the first customer and a second input from the second customer matching in the group-creation forum.

18. The system of claim 16, wherein the memory resources are further configured to direct the processor resources to:
create a sublist of a sub-number of customers from the list of promotion-eligible customers, wherein the sub-number of customers has a second input matching a first input from a first customer; and
provide the group-creation forum for the first customer to auction to the sublist of customers to form the qualifying group with the first customer, wherein the first customer comprises a group of customers.

19. The system of claim 16, wherein the memory resources are further configured to direct the processor resources to:
create a sublist of a sub-number of groups from the list of promotion-eligible customers, wherein the sub-number of groups has a second input matching a first input from a first customer; and
provide the group-creation forum for the first customer to auction to the sublist.
